(19) United States
(12) Patent Application Publication
(10) Pub. No.: US 2025/0093529 A1
(43) Pub. Date: Mar. 20, 2025

(54) METHOD AND SYSTEM FOR MEASUREMENT REJECTION IN AIDED NAVIGATION

(71) Applicant: Honeywell International Inc., Charlotte, NC (US)

(72) Inventors: Zafer Vatansever, Falcon Heights, MN (US); Drew Alan Karnick, Blaine, MN (US); Emma Jane Grant, Minneapolis, MN (US)

(73) Assignee: Honeywell International Inc., Charlotte, NC (US)

(21) Appl. No.: 18/811,579

(22) Filed: Aug. 21, 2024

Related U.S. Application Data
(60) Provisional application No. 63/582,734, filed on Sep. 14, 2023.

(51) Int. Cl. G01S 19/47

(52) U.S. Cl. CPC G01S 19/47

(57) ABSTRACT

A system comprises a processor onboard a vehicle, an onboard aiding source, and onboard inertial sensors. The processor includes a prediction module that propagates navigation error states, and a residual computation module that computes a measurement residual and measurement residual variance based on aiding measurements and navigation error states. A measurement monitoring module comprises a measurement monitor selection switch that selects between a normalized measurement residual monitor, and a Chi squared measurement monitor. When selected, the normalized measurement residual monitor performs a first aiding measurement validation process that determines whether a normalized measurement residual is less than a first user selected threshold. If yes, then the aiding measurement is valid. When selected, the Chi squared measurement monitor performs a second aiding measurement validation process that determines whether a measurement residual error squared is less than a second user selected threshold. If yes, then the aiding measurement is valid.

### CROSS REFERENCE TO RELATED APPLICATION

This application claims the benefit of and priority to U.S. Provisional Application No. 63/582,734, filed on Sep. 14, 2023, the disclosure of which is herein incorporated by reference.

### BACKGROUND

In a navigation system that “blends” information from multiple sources, including inertial sensors in an inertial navigation system (INS) and global navigation satellite system (GNSS) sensors, the INS-GNSS navigation solutions can significantly degrade due to inaccurate GNSS signals. For example, when a vehicle with such a navigation system is in an “Urban Canyon” environment, the GNSS signals can be subjected to multipath, reflections, obstructions in the line-of-sight, and the like. This can result in a sensor fusion algorithm of the navigation system suffering from the use of erroneous GNSS measurements. Such “erroneous” measurements means that a GNSS receiver provides position, velocity, attitude, and their associated variances, which are not consistent with the sensor fusion models implemented in a Kalman filter.

### SUMMARY

A system comprises at least one processor onboard a vehicle; an aiding source onboard the vehicle and operatively coupled to the at least one processor; and one or more inertial sensors onboard the vehicle and operatively coupled to the at least one processor. The at least one processor includes a set of processing modules comprising a prediction module operative to propagate estimated vehicle navigation error states, and a residual computation module in operative communication with the prediction module and the aiding source. The residual computation module is operative to compute a measurement residual and a measurement residual variance, based on at least one aiding measurement from the aiding source and the estimated vehicle navigation error states from the prediction module. In addition, a measurement monitoring module is in operative communication with the residual computation module.

The measurement monitoring module comprises a measurement monitor selection switch operative to select between a normalized measurement residual monitor, and a Chi squared measurement monitor. When selected, the normalized measurement residual monitor is operative to perform a first aiding measurement validation process comprising determining whether a normalized measurement residual is less than a first user selected threshold. If the normalized measurement residual is less than the first user selected threshold, then an indication is provided that the at least one aiding measurement is valid. If the normalized measurement residual is not less than the first user selected threshold, then an indication is provided that the at least one aiding measurement is invalid. When selected, the Chi squared measurement monitor is operative to perform a second aiding measurement validation process comprising determining whether a measurement residual error squared is less than a second user selected threshold. If the measurement residual error squared is less than the second user selected threshold, then an indication is provided that the at least one aiding measurement is valid. If the measurement residual error squared is not less than the second user selected threshold, then an indication is provided that the at least one aiding measurement is invalid. A correction module is in operative communication with the measurement monitoring module. The correction module is configured to update the estimated vehicle navigation error states based on the first or second aiding measurement validation processes.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a block diagram of a system for measurement validation in aided navigation, according to one embodiment;

FIGS. 2A-2C are graphs of example navigation results of using the system of FIG. 1, compared to a reference signal and a prior method; and

FIGS. 3A and 3B are flow diagrams of a method for measurement validation in aided navigation, according to an exemplary implementation.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

A method and system for measurement rejection in aided navigation used with one or more inertial sensors in an INS, such as micro-electro-mechanical systems (MEMS) inertial sensors, are described herein.

A combined measurement validation methodology is disclosed, which combines a normalized measurement residual monitor, and a normalized measurement residual error squared monitor (i.e., Chi-squared monitor). The present methodology employs a switching arrangement based on measurement residual variance, such as a statistical discriminator, to select between the monitors. By using the switching arrangement, aiding measurements such as from a GNSS receiver can be rejected that are not consistent with implemented sensor fusion models, thus providing improved vehicle navigation.

The present approach can be employed with a variety of GNSS implementations, including Global Positioning System (GPS), Galileo (European Union), GLONASS (Russia), Beidou (China), and Nav-IC (India). The present method deals with the estimate of accuracy provided by the GNSS receiver itself, including for position, velocity, and attitude measurements, and does not use pseudo-ranges, delta ranges, clock bias, or drift.

The benefits of the present approach include improved navigation accuracy in rejecting inaccurate aiding measurements such as from a GNSS receiver; allowing for the use of lower cost GNSS receivers; and for operations in GNSS-denied environments such as urban canyons and coming out of tunnels.

The accuracy of GNSS measurements can be degraded without “losing” acquisition of the GNSS signal. In addition, the accuracy of GNSS measurements can be degraded when GNSS signals are lost and then reacquired. The present method can be used during the acquisition or reacquisition of GNSS signals, as well as the scenario where a GNSS receiver has acquired the GNSS signal. The method rejects GNSS measurements that are not consistent with expected measurements provided by a sensor fusion model implemented in a Kalman filter.

Further details of various embodiments are described hereafter and with reference to the drawings.

As indicated above, a combined measurement validation methodology is disclosed that employs two monitoring techniques, including normalized measurement residual monitoring and normalized residual error squared monitoring (Chi squared test). The monitoring techniques are implemented to prevent a sensor fusion algorithm from using erroneous aiding measurements during vehicle navigation.

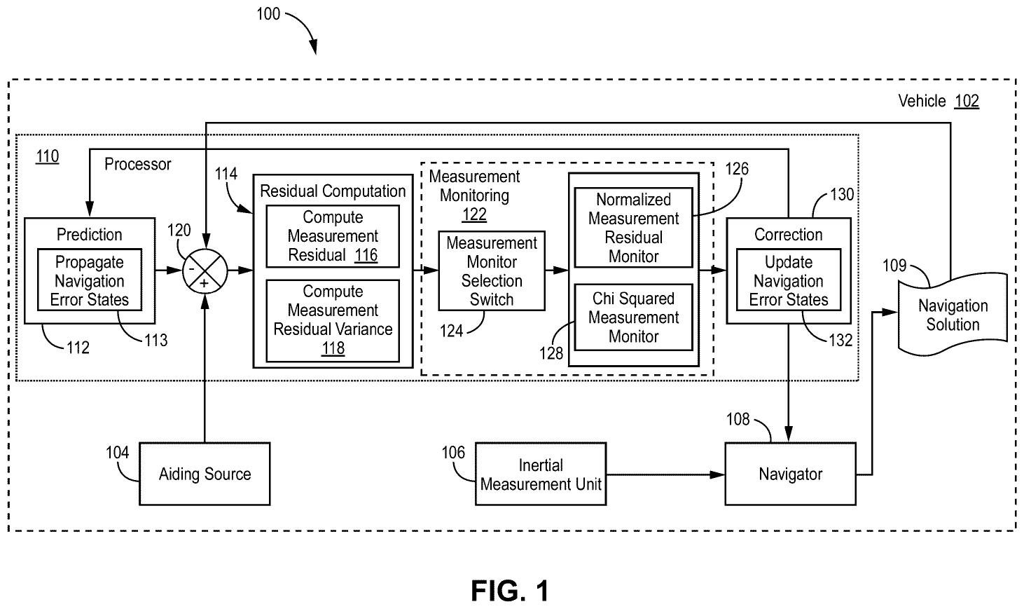

FIG. 1 is a block diagram of a system 100 for measurement validation or rejection in aided navigation, which employs the above monitoring techniques, according to one embodiment. The system 100 is implemented for a vehicle 102, such as an aircraft (e.g., uncrewed aerial vehicle), a land vehicle, a water vehicle, or the like, which includes various onboard sensors. Such sensors include an aiding source 104 such as a GNSS receiver, and an inertial measurement unit (IMU) 106 that includes multiple inertial sensors such as gyroscopes and accelerometers. The IMU 106 is operative to produce inertial measurements that are sent to an onboard navigator unit 108 that includes an INS. The navigator unit 108 is operative to compute and output a navigation solution 109, based on estimated vehicle kinematic state statistics, for use in safely navigating vehicle 102.

At least one onboard processor 110 is operatively coupled with aiding source 104 and navigator unit 108. The processor 110 hosts a set of processing modules that are operative to provide a measurement validation algorithm according to the present approach, which is described in further detail hereafter. The processing modules in processor 110 include a prediction module 112 operative to propagate estimated vehicle navigation error states (block 113), and a residual computation module 114 in operative communication with prediction module 112 and aiding source 104 through a mixer module 120. The mixer module 120 is operative to combine at least one aiding measurement from aiding source 104 with navigation estimates from navigation solution 109. The mixer module 120 is operative to send an output signal to residual computation module 114. The residual computation module 114 is operative to compute a measurement residual (block 116) and a measurement residual variance (block 118), based on the aiding measurement from aiding source 104, the navigation error states from prediction module 112, and the navigation estimates from navigation solution 109.

In addition, a measurement monitoring module 122 is in operative communication with residual computation module 114. The measurement monitoring module 122 comprises a measurement monitor selection switch 124 operative to select between a normalized measurement residual monitor 126, and a Chi squared measurement monitor 128. A correction module 130 is in operative communication with measurement monitoring module 122 and prediction module 112. The correction module 130 is configured to update the estimated vehicle navigation error states (block 132) based on the aiding measurement validity determinations of measurement monitoring module 122.

During a processing operation, residual computation module 114 sends the computed measurement residual (from block 116) and measurement residual variance (from block 118) to measurement monitoring module 122. There, measurement monitor selection switch 124 uses the measurement residual variance to select between the normalized measurement residual monitor 126 and the Chi squared measurement monitor 128. When selected, the normalized measurement residual monitor 126 determines whether the normalized measurement residual is less than a first user selected threshold. If the normalized measurement residual is less than the first user selected threshold, then the aiding measurement is valid. If the normalized measurement residual is not less than the first user selected threshold, then the aiding measurement is invalid.

When the Chi squared measurement monitor 128 is selected, it determines whether the measurement residual error squared is less than a second user selected threshold. If the measurement residual error squared is less than the second user selected threshold, then the aiding measurement(s) is valid. If the measurement residual error squared is not less than the second user selected threshold, then the aiding measurement(s) is invalid.

If the aiding measurement is determined to be valid, then the aiding measurement is sent to navigator unit 108 for further processing by a sensor fusion algorithm in navigator unit 108. If the aiding measurement is determined to be invalid, then the aiding measurement is not used, and the processing operation returns to prediction module 112 to continue monitoring of additional aiding measurements.

Further details of the aiding measurement validation algorithm according to the present approach, are described as follows.

### Measurement Monitors

The following equations can be used for normalized measurement residual monitoring, such as in the normalized measurement residual monitor 124:

$$v = {z}_{k} - h ( {\hat{x}}_{k}^{-} ) \qquad ( 1 )$$

$$S = {H}_{k} {P}_{k}^{-} {H}_{k}^{T} + {R}_{K} \qquad ( 2 )$$

$$Y = \frac{\vert v \vert}{\sqrt{S}} \qquad ( 3 )$$

$$\begin{matrix}If Y < threshold , measurement = valid \\ else measurement = invalid\end{matrix} \qquad ( 4 )$$

where:
in equation (1), v is a measurement residual, zₖ is a measurement residual, and h(\hat{x}ₖ⁻) is a measurement model;
in equation (2), S is a measurement residual covariance, HₖPₖ⁻Hₖ^{T} is a prior error covariance represented in measurement space, and R_{K} is measurement noise (e.g., GNSS noise);
in equation (3), Y is a normalized measurement residual; and
equation (4) is the normalized measurement residual monitor.
   In theory, Y is a zero mean normal distribution. A typical threshold value used is six. Normalized measurement residual monitoring is used for sequential measurement processing, where the dimension of v and S is one.

The following equations can be used for normalized residual error squared monitoring, such as in the Chi squared measurement monitor 126:

$$X = v ( {S}^{- 1} ) {v}^{′} \qquad ( 5 )$$

$$\begin{matrix}If X < threshold , measurement = valid , \\ else measurement = invalid\end{matrix} \qquad ( 6 )$$

where:
in equation (5), X is a measurement residual error squared (Mahalanobis distance squared, also known as the Chi-Squared test), v′ is a measurement residual, and S is a measurement residual covariance; and
equation (6) is the normalized residual error squared monitor.
   The threshold is chosen from a Chi-Squared distribution. The normalized residual error squared monitoring is stricter than the normalized measurement residual monitoring, and can be used with sequential and batch measurements. This means the dimension of v and S can be one, or one-by-N, or N-by-N, respectively.

### Measurement Monitor Selection Switch

Time correlated measurements, system modelling errors, and inaccurate noise modelling violate the assumption of zero mean residual residuals. In the context of an extended Kalman filter problem, equation (5) gives the measurement residual variance. When large values of a prior error covariance matrix (P) and inaccurate measurement noise values (R) exist, the sensor fusion algorithm will underestimate the posterior error covariance and use the ‘inaccurate’ GNSS measurements.

The measurement validation methods described above have their shortcomings if used separately. The normalized measurement residual monitoring does not perform well in urban canyons; and the Chi-Squared method rejects healthy measurements during start-up and sensor recovery scenarios. Therefore, a combination of these measurement validation methods is needed to provide improved navigation accuracy.

For example, in using measurement monitor selection switch 124, if HPH^{T}<a exists, it can be assumed that measurement errors do not exist, therefore, the stricter measurement rejection provided by the Chi squared method is used. During initialization or recovery from GNSS loss, monitoring of measurements is still needed, but if HPH^{T}>a exists, then the normalized measurement residual monitoring is used. The parameter a is chosen empirically based on observing many datasets.

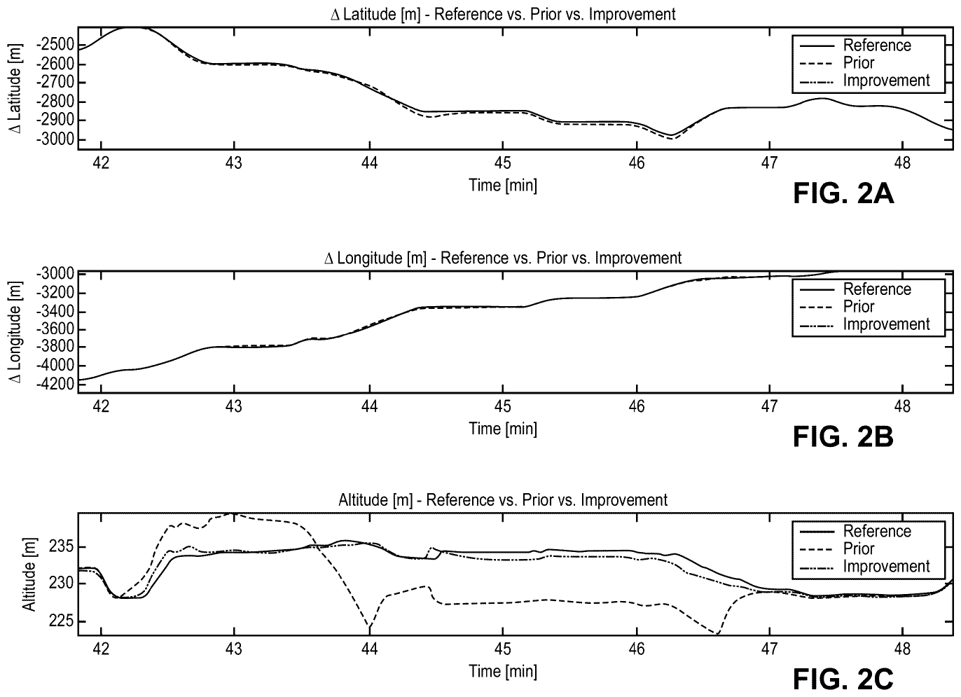

FIGS. 2A-2C are graphs showing the improved navigation results of using the present measurement validation methodology, with respect to a reference signal and a prior method. FIG. 2A includes a plot of delta latitude with respect to time, for the reference signal vs. the prior method vs. the present improvement. FIG. 2B includes a plot of delta longitude with respect to time, for the reference signal vs. the prior method vs. the present improvement. FIG. 2C includes a plot of altitude with respect to time, for the reference signal vs. the prior method vs. the present improvement. The time interval chosen in FIGS. 2A-2C corresponds to an urban canyon area where GNSS signals are degraded. All plots show an improvement in tracking of the reference signal versus the prior method. FIGS. 2A and 2B show similar results for delta latitude and delta longitude. FIG. 2C shows an even larger improvement over the prior method.

In particular, in FIG. 2A, the maximum deviation of prior latitude from the reference latitude is 30 meters; with the present improvement, the maximum deviation is 4 meters. In FIG. 2B, the maximum deviation of prior longitude from the reference longitude is 16 meters; with the present improvement, the maximum deviation is 5 meters. In FIG. 2C, the maximum deviation of prior altitude from the reference altitude is 12 meters; with the present improvement, the maximum deviation is 2 meters.

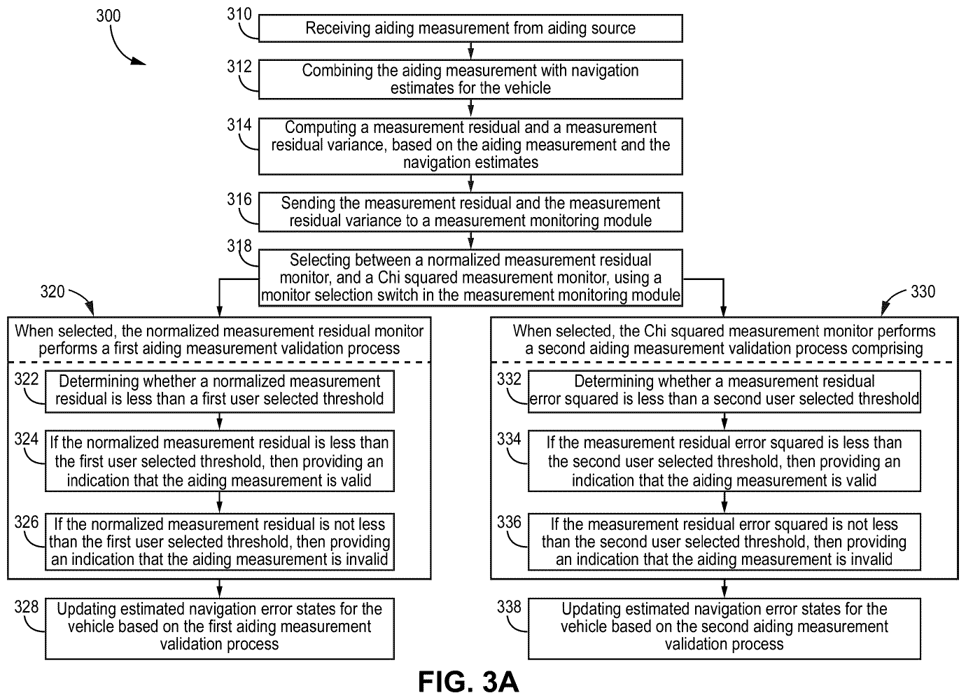

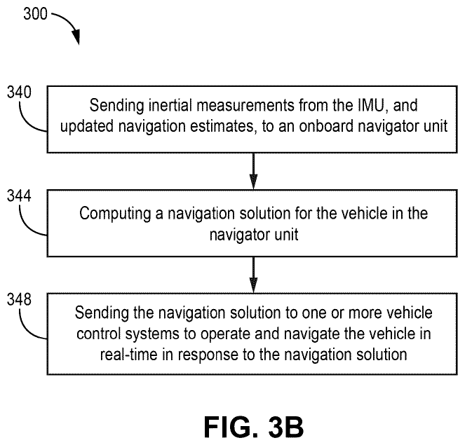

FIGS. 3A and 3B are flow diagrams of a method 300 for measurement validation in aided navigation, according to an exemplary implementation of the present approach. The method 300 can be implemented by a processor onboard a vehicle, which is in communication with an onboard aiding source such as a GNSS receiver and an onboard IMU. The processor hosts a set of processing modules that include instructions, executable by the processor, to perform method 300.

As shown in FIG. 3A, the method 300 comprises receiving at least one aiding measurement from the aiding source (block 310); combining the aiding measurement with estimated navigation states for the vehicle (block 312); and computing a measurement residual and a measurement residual variance, based on the aiding measurement and the estimated navigation states (block 314). The method 300 further includes sending the measurement residual and the measurement residual variance to a measurement monitoring module (block 316); and selecting between a normalized measurement residual monitor, and a Chi squared measurement monitor, using a monitor selection switch in the measurement monitoring module (block 318).

When selected, the normalized measurement residual monitor performs a first aiding measurement validation process (block 320), which includes determining whether a normalized measurement residual is less than a first user selected threshold (block 322). If the normalized measurement residual is less than the first user selected threshold, then an indication is provided that the aiding measurement is valid (block 324). If the normalized measurement residual is not less than the first user selected threshold, then an indication is provided that the aiding measurement is invalid (block 326). The method 300 then updates estimated navigation error states for the vehicle based on the results of the first aiding measurement validation process (block 328).

The Chi squared measurement monitor, when selected, performs a second aiding measurement validation process (block 330), which comprises determining whether a measurement residual error squared is less than a second user selected threshold (block 332). If the measurement residual error squared is less than the second user selected threshold, then an indication is provided that the aiding measurement is valid (block 334). If the measurement residual error squared is not less than the second user selected threshold, then an indication is provided that the aiding measurement is invalid (block 336). The method 300 then updates estimated navigation error states for the vehicle based on the results of the second aiding measurement validation process (block 338).

As shown in FIG. 3B, the method 300 can further include sending inertial measurements from the IMU, and updated navigation estimates, to an onboard navigator unit (block 340); and computing a navigation solution for the vehicle in the navigator unit (block 344). The method 300 can then send the navigation solution to one or more vehicle control systems to operate and navigate the vehicle in real-time in response to the navigation solution (block 348).

The processing units and/or other computational devices used in the method and system described herein may be implemented using software, firmware, hardware, or appropriate combinations thereof. The processing unit and/or other computational devices may be supplemented by, or incorporated in, specially-designed application-specific integrated circuits (ASICs) or field programmable gate arrays (FPGAs). In some implementations, the processing unit and/or other computational devices may communicate through an additional transceiver with other computing devices outside of the navigation system, such as those associated with a management system or computing devices associated with other subsystems controlled by the management system. The processing unit and/or other computational devices can also include or function with software programs, firmware, or other computer readable instructions for carrying out various process tasks, calculations, and control functions used in the methods and systems described herein.

The methods described herein may be implemented by computer executable instructions, such as program modules or components, which are executed by at least one processor or processing unit. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer readable instructions. These instructions are typically stored on appropriate computer program products that include computer readable media used for storage of computer readable instructions or data structures. Such a computer readable medium may be available media that can be accessed by a general purpose or special purpose computer or processor, or any programmable logic device.

Suitable computer readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can be used to carry or store desired program code in the form of computer executable instructions or data structures.

### Example Embodiments

Example 1 includes a system comprising: at least one processor onboard a vehicle; an aiding source onboard the vehicle and operatively coupled to the at least one processor; and one or more inertial sensors onboard the vehicle and operatively coupled to the at least one processor; wherein the at least one processor includes a set of processing modules comprising: a prediction module operative to propagate estimated vehicle navigation error states; a residual computation module in operative communication with the prediction module and the aiding source, the residual computation module operative to compute a measurement residual and a measurement residual variance, based on at least one aiding measurement from the aiding source and the estimated vehicle navigation error states from the prediction module; a measurement monitoring module in operative communication with the residual computation module, the measurement monitoring module comprising: a measurement monitor selection switch operative to select between a normalized measurement residual monitor, and a Chi squared measurement monitor; wherein when selected, the normalized measurement residual monitor is operative to perform a first aiding measurement validation process comprising: determining whether a normalized measurement residual is less than a first user selected threshold; wherein if the normalized measurement residual is less than the first user selected threshold, then providing an indication that the at least one aiding measurement is valid; wherein if the normalized measurement residual is not less than the first user selected threshold, then providing an indication that the at least one aiding measurement is invalid; wherein when selected, the Chi squared measurement monitor is operative to perform a second aiding measurement validation process comprising: determining whether a measurement residual error squared is less than a second user selected threshold; wherein if the measurement residual error squared is less than the second user selected threshold, then providing an indication that the at least one aiding measurement is valid; wherein if the measurement residual error squared is not less than the second user selected threshold, then providing an indication that the at least one aiding measurement is invalid; and a correction module in operative communication with the measurement monitoring module, the correction module configured to update the estimated vehicle navigation error states based on the first or second aiding measurement validation processes.

Example 2 includes the system of Example 1, wherein the aiding source comprises a global navigation satellite system (GNSS) receiver.

Example 3 includes the system of any of Examples 1-2, wherein the one or more inertial sensors comprise an inertial measurement unit (IMU) that is operative to produce inertial measurements for the vehicle.

Example 4 includes the system of Example 3, further comprising: an onboard navigator unit configured to receive the inertial measurements from the IMU, and updated navigation estimates from the correction module; wherein the navigator unit is operative to compute and output a navigation solution for the vehicle.

Example 5 includes the system of Example 4, wherein the onboard navigator unit includes an inertial navigation system (INS) operative to generate estimated vehicle kinematic state statistics based on the inertial measurements from the IMU and the updated navigation estimates.

Example 6 includes the system of Example 5, wherein the navigation solution for the vehicle is computed based on the estimated vehicle kinematic state statistics.

Example 7 includes the system of any of Examples 1-6, further comprising: a mixer module operative to receive the at least one aiding measurement from the aiding source and the estimated vehicle navigation error states from the prediction module; wherein the mixer module is operative to send an output signal to the residual computation module.

Example 8 includes the system of any of Examples 1-7, wherein the vehicle comprises an aircraft, a land vehicle, or a water vehicle.

Example 9 includes the system of Example 8, wherein the aircraft is an uncrewed aerial vehicle.

Example 10 includes a method comprising: providing a processor onboard a vehicle, an aiding source onboard the vehicle, and one or more inertial sensors onboard the vehicle; wherein the processor hosts a set of processing modules that include instructions, executable by the processor, to perform a process comprising: receiving an aiding measurement from the aiding source; combining the aiding measurement with navigation estimates for the vehicle; computing a measurement residual and a measurement residual variance, based on the aiding measurement and the navigation estimates; sending the measurement residual and the measurement residual variance to a measurement monitoring module; and selecting between a normalized measurement residual monitor, and a Chi squared measurement monitor, using a measurement monitor selection switch; wherein when selected, the normalized measurement residual monitor performs a first aiding measurement validation process comprising: determining whether a normalized measurement residual is less than a first user selected threshold; if the normalized measurement residual is less than the first user selected threshold, then providing an indication that the aiding measurement is valid; if the normalized measurement residual is not less than the first user selected threshold, then providing an indication that the aiding measurement is invalid; wherein when selected, the Chi squared measurement monitor performs a second aiding measurement validation process comprising: determining whether a measurement residual error squared is less than a second user selected threshold; if the measurement residual error squared is less than the second user selected threshold, then providing an indication that the aiding measurement is valid; if the measurement residual error squared is not less than the second user selected threshold, then providing an indication that the aiding measurement is invalid; and updating estimated navigation error states for the vehicle based on the first or second aiding measurement validation processes.

Example 11 includes the method of Example 10, wherein the aiding source comprises a global navigation satellite system (GNSS) receiver.

Example 12 includes the method of Example 10, wherein the one or more inertial sensors comprise an inertial measurement unit (IMU) that produces inertial measurements for the vehicle.

Example 13 includes the method of Example 12, further comprising: sending the inertial measurements from the IMU, and updated navigation estimates, to an onboard navigator unit; computing a navigation solution for the vehicle in the navigator unit; and sending the navigation solution to one or more vehicle control systems to operate and navigate the vehicle in real-time in response to the navigation solution.

Example 14 includes the method of Example 13, wherein the navigator unit includes an inertial navigation system (INS) that generates estimated vehicle kinematic state statistics based on the inertial measurements from the IMU and the updated navigation estimates.

Example 15 includes the method of Example 14, wherein the navigation solution for the vehicle is computed based on the estimated vehicle kinematic state statistics.

Example 16 includes the method of any of Examples 10-15, wherein the vehicle comprises an aircraft, a land vehicle, or a water vehicle.

Example 17 includes the method of Example 16, wherein the aircraft is an uncrewed aerial vehicle.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A system comprising:
at least one processor onboard a vehicle;
an aiding source onboard the vehicle and operatively coupled to the at least one processor; and
one or more inertial sensors onboard the vehicle and operatively coupled to the at least one processor;
wherein the at least one processor includes a set of processing modules comprising:
a prediction module operative to propagate estimated vehicle navigation error states;
a residual computation module in operative communication with the prediction module and the aiding source, the residual computation module operative to compute a measurement residual and a measurement residual variance, based on at least one aiding measurement from the aiding source and the estimated vehicle navigation error states from the prediction module;
a measurement monitoring module in operative communication with the residual computation module, the measurement monitoring module comprising:
a measurement monitor selection switch operative to select between a normalized measurement residual monitor, and a Chi squared measurement monitor;
wherein when selected, the normalized measurement residual monitor is operative to perform a first aiding measurement validation process comprising:
determining whether a normalized measurement residual is less than a first user selected threshold;
wherein if the normalized measurement residual is less than the first user selected threshold, then providing an indication that the at least one aiding measurement is valid;
wherein if the normalized measurement residual is not less than the first user selected threshold, then providing an indication that the at least one aiding measurement is invalid;
wherein when selected, the Chi squared measurement monitor is operative to perform a second aiding measurement validation process comprising:
determining whether a measurement residual error squared is less than a second user selected threshold;
wherein if the measurement residual error squared is less than the second user selected threshold, then providing an indication that the at least one aiding measurement is valid;
wherein if the measurement residual error squared is not less than the second user selected threshold, then providing an indication that the at least one aiding measurement is invalid; and
a correction module in operative communication with the measurement monitoring module, the correction module configured to update the estimated vehicle navigation error states based on the first or second aiding measurement validation processes.

2. The system of claim 1, wherein the aiding source comprises a global navigation satellite system (GNSS) receiver.

3. The system of claim 1, wherein the one or more inertial sensors comprise an inertial measurement unit (IMU) that is operative to produce inertial measurements for the vehicle.

4. The system of claim 3, further comprising:
an onboard navigator unit configured to receive the inertial measurements from the IMU, and updated navigation estimates from the correction module;
wherein the navigator unit is operative to compute and output a navigation solution for the vehicle.

5. The system of claim 4, wherein the onboard navigator unit includes an inertial navigation system (INS) operative to generate estimated vehicle kinematic state statistics based on the inertial measurements from the IMU and the updated navigation estimates.

6. The system of claim 5, wherein the navigation solution for the vehicle is computed based on the estimated vehicle kinematic state statistics.

7. The system of claim 1, further comprising:
a mixer module operative to receive the at least one aiding measurement from the aiding source and the estimated vehicle navigation error states from the prediction module;
wherein the mixer module is operative to send an output signal to the residual computation module.

8. The system of claim 1, wherein the vehicle comprises an aircraft, a land vehicle, or a water vehicle.

9. The system of claim 8, wherein the aircraft is an uncrewed aerial vehicle.

10. A method comprising:
providing a processor onboard a vehicle, an aiding source onboard the vehicle, and one or more inertial sensors onboard the vehicle;
wherein the processor hosts a set of processing modules that include instructions, executable by the processor, to perform a process comprising:
receiving an aiding measurement from the aiding source;
combining the aiding measurement with navigation estimates for the vehicle;
computing a measurement residual and a measurement residual variance, based on the aiding measurement and the navigation estimates;
sending the measurement residual and the measurement residual variance to a measurement monitoring module; and
selecting between a normalized measurement residual monitor, and a Chi squared measurement monitor, using a measurement monitor selection switch;
wherein when selected, the normalized measurement residual monitor performs a first aiding measurement validation process comprising:
determining whether a normalized measurement residual is less than a first user selected threshold;
if the normalized measurement residual is less than the first user selected threshold, then providing an indication that the aiding measurement is valid;
if the normalized measurement residual is not less than the first user selected threshold, then providing an indication that the aiding measurement is invalid;
wherein when selected, the Chi squared measurement monitor performs a second aiding measurement validation process comprising:
determining whether a measurement residual error squared is less than a second user selected threshold;
if the measurement residual error squared is less than the second user selected threshold, then providing an indication that the aiding measurement is valid;
if the measurement residual error squared is not less than the second user selected threshold, then providing an indication that the aiding measurement is invalid; and
updating estimated navigation error states for the vehicle based on the first or second aiding measurement validation processes.

11. The method of claim 10, wherein the aiding source comprises a global navigation satellite system (GNSS) receiver.

12. The method of claim 10, wherein the one or more inertial sensors comprise an inertial measurement unit (IMU) that produces inertial measurements for the vehicle.

13. The method of claim 12, further comprising:
sending the inertial measurements from the IMU, and updated navigation estimates, to an onboard navigator unit;
computing a navigation solution for the vehicle in the navigator unit; and
sending the navigation solution to one or more vehicle control systems to operate and navigate the vehicle in real-time in response to the navigation solution.

14. The method of claim 13, wherein the navigator unit includes an inertial navigation system (INS) that generates estimated vehicle kinematic state statistics based on the inertial measurements from the IMU and the updated navigation estimates.

15. The method of claim 14, wherein the navigation solution for the vehicle is computed based on the estimated vehicle kinematic state statistics.

16. The method of claim 10, wherein the vehicle comprises an aircraft, a land vehicle, or a water vehicle.

17. The method of claim 16, wherein the aircraft is an uncrewed aerial vehicle.
